(19) United States
(12) Patent Application Publication
(10) Pub. No.: US 2018/0181335 A1
(43) Pub. Date: Jun. 28, 2018

(54) APPARATUS AND METHOD TO SPEED UP MEMORY FREQUENCY SWITCH FLOW

(71) Applicant: MEDIATEK INC., Hsin-Chu (TW)

(72) Inventor: Te-Ping LIU, Dayuan Township (TW)

(21) Appl. No.: 15/902,002

(22) Filed: Feb. 22, 2018

Related U.S. Application Data
(63) Continuation-in-part of application No. 14/874,832, filed on Oct. 5, 2015, now Pat. No. 9,940,050.

(51) Int. Cl. G06F 3/06

(52) U.S. Cl. CPC G06F 3/0634; G06F 3/0673; G06F 3/0659; G06F 3/0611

(57) ABSTRACT

A computing system for accessing a dynamic random access memory (DRAM) includes a processing circuit, a queue, and a DRAM controller. The processing circuit is configured for issuing an early notification signal before issuing a clock frequency switch signal; the early notification signal notifies of an approaching clock frequency switch signal and the clock frequency switch signal requests a change of frequency of a DRAM clock. The queue stores commands to be sent to the DRAM for a plurality of operations to access the DRAM. The DRAM controller is configured for controlling access to the DRAM and the DRAM controller manages to reschedule the commands of the queue to issue ongoing commands for currently processed operation, issue a command for modifying the setting of the DRAM and pause the issuance of remaining unfinished commands of remaining unfinished operations to the DRAM upon receiving the early notification signal.

### CROSS REFERENCE TO RELATED APPLICATIONS

This application is a Continuation-In-Part of pending U.S. patent application Ser. No. 14/874,832, filed on Oct. 5, 2015, the content of which is hereby incorporated by reference in its entirety.

### BACKGROUND OF THE INVENTION

### Field of the Invention

The invention relates to a dynamic random access memory (DRAM) controller and DRAM control method, and more particularly, to a method for speeding up memory clock frequency change flow within a computing system, and an apparatus thereof.

### Description of the Related Art

Dynamic random access memory (DRAM) is a type of volatile memory that stores each data bit in an individual capacitor. DRAM has a variety of forms such as synchronous DRAM (SDRAM), double data rate (DDR) SDRAM, DDR2 SDRAM, and DDR3 SDRAM, which have different respective densities or operating speeds.

A memory controller, such as a DRAM controller, is a circuit that manages the flow of data to and from a memory such as DRAM. The memory controller controls reading and writing by selecting row and column data addresses of the memory.

As modern computing systems are required to provide more computing capability, integrated circuit (IC) chips or system on chip (SoC) within these computing systems are operating at increasingly faster clock speeds. At the same time, these IC chips consume more power due to faster clock speeds. However, in many computing environments such as a mobile computing system, it is desirable to reduce power consumption. One common technique to save power is to dynamically manage system power consumption through clock-frequency scaling. For example, the clock frequency for an IC may be reduced during periods of operation when the workload is light, thereby reducing power consumption. Note that, when the workload increases again, the clock frequency can be restored to its previous level.

A memory subsystem within a computer system consumes a significant amount of power. Hence, providing power savings in a memory subsystem through dynamic clock-frequency scaling is not uncommon. Changing the clock frequency of a DRAM typically involves: pausing or discarding all outstanding memory subsystem operations; changing the DRAM clock frequency to a new value; and resuming or repeating the memory operations. Unfortunately, suspending memory operations for a long period of time during clock frequency changes is not desirable for many applications, in particular during real-time applications such as audio and video playback. In order not to suffer system performance degradation, fastening the clock frequency change flow of a DRAM subsystem as quickly as possible while satisfying relevant DRAM operation timing constraints to avoid a system malfunction is needed.

Hence, there is a need for a clock frequency changing technique to speed up the DRAM clock frequency change flow efficiently.

### BRIEF SUMMARY OF THE INVENTION

A computing system for accessing a dynamic random access memory (DRAM) and a DRAM accessing method are provided. An exemplary embodiment of the computing system comprises a processing circuit, a queue, and a DRAM controller. The processing circuit is configured for issuing an early notification signal before issuing a clock frequency switch signal, wherein the early notification signal notifies of an approaching clock frequency switch signal and the clock frequency switch signal requests a change of frequency of a DRAM clock. The queue comprises entries for storing commands to be sent to the DRAM for a plurality of operations to access the DRAM. The DRAM controller is configured for controlling access to the DRAM and the DRAM controller manages to reschedule the commands of the queue to issue ongoing commands for currently processed operations, issue a command for modifying the setting of the DRAM and pause the issuance of remaining unfinished commands of remaining unfinished operations to the DRAM upon receiving the early notification signal.

An exemplary embodiment of the DRAM accessing method is provided. The DRAM accessing method comprises the steps of: issuing, by a processing circuit, an early notification signal before issuing a clock frequency switch signal, wherein the early notification signal notifies of an approaching clock frequency switch signal and the clock frequency switch signal requests a change of frequency of a DRAM clock; storing commands that are ready to be sent to a DRAM for a plurality of operations to access the DRAM into a queue; and rescheduling, by a DRAM controller, the commands of the queue to issue ongoing commands for currently processed operation, issuing a command for modifying the setting of the DRAM and pausing the issuance of remaining unfinished commands of remaining unfinished operations to the DRAM upon receiving the early notification signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a timing diagram illustrative of timing constraints imposed on a command signal for writing data to a DRAM.

FIG. 2 illustrates a block diagram of a DRAM subsystem according to another embodiment of the invention;

FIG. 3 illustrates how to discard and re-schedule commands of a queue according to some embodiments of the invention;

FIG. 4 illustrates how to discard and re-schedule commands of a queue according to some embodiments of the invention;

FIG. 5 illustrates how to discard and re-schedule commands of a queue according to some embodiments of the invention;

FIG. 6 illustrates how to discard and re-schedule commands of a queue according to some embodiments of the invention;

FIG. 7 illustrates how to discard and re-schedule commands of a queue according to some embodiments of the invention; and

FIG. 8 is a flow chart illustrating a DRAM accessing method according to an embodiment of the invention.

### DETAILED DESCRIPTION OF THE INVENTION

Various embodiments of the invention are described with reference to the accompanying drawings in detail. The same reference numbers are used throughout the drawings to refer to the same or like components. These embodiments are made for the purpose of illustrating the general principles of the invention and should not be taken in a limiting sense. Detailed descriptions of well-known functions and structures are omitted to avoid obscuring the subject matter of the invention.

It should be noted that different references to “an” or “one” embodiment in this disclosure are not necessarily to the same embodiment, and such references mean at least one. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

The computing system according to an embodiment of the invention may be implemented as or within an electronic device; the electronic device may be, but is not limited to, a Personal Digital Assistant (PDA), a smartphone, a tablet Personal Computer (PC), a Portable Multimedia Player (PMP), an electronic book terminal, a notebook PC, a netbook computer, or an Ultra Mobile Personal Computer (UMPC).

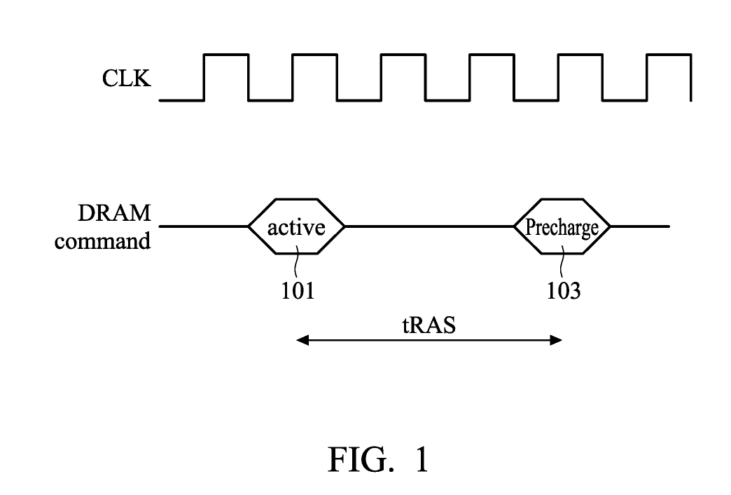

FIG. 1 shows a timing diagram illustrative of timing constraints imposed on a command signal for accessing a DRAM. For the sake of brevity, an associated address signal and data signal waveforms for the DRAM are omitted. In the timing diagram, the active command 101 indicates a row access time during which a row address is issued from a DRAM controller to a DRAM, and the precharge command 103 indicates a precharge command time during which a precharge command is issued from the DRAM controller to the DRAM. It is noted that a row active time tRAS, defined in a particular specification for the DRAM, is needed between the active command 101 and the precharge command 103. In other words, the active time tRAS requires an absolute timing gap between activating a row of the DRAM and pre-charging the activated row of the DRAM. For example, when the active time tRAS is 20 ns, the DRAM controller cannot issue the precharge command 103 to the DRAM within 20 ns after issuing the active command 101. To satisfy the tRAS requirement, the DRAM controller may use a counter to count a corresponding clock cycle number of a clock for the DRAM controller and/or the DRAM. For example, if the clock CLK for the DRAM subsystem has a frequency of 200MHz (i.e. the clock cycle is 5 ns), the DRAM controller would do the following: issue the active command 101; count at least 4 clock cycles of the clock CLK; and issue the precharge command 103. The DRAM controller can, of course, count many more than 4 clock cycles; however, system efficiency may decrease as a greater timing gap than necessary (e.g. much larger than the active time tRAS) is reserved.

When the frequency of the clock CLK is changed, the corresponding clock cycle count for satisfying the active time tRAS requirement may change as well. For instance, if the frequency of the clock CLK is switched from 200 MHz to 500 MHz, the DRAM controller has to count at least 10 clock cycles of the clock CLK under the new clock frequency instead of 4 clock cycles. Otherwise, the timing margin between the active command 101 and the precharge command 103 will not be large enough to meet the DRAM specification and an error may occur during access to the DRAM.

To manage the DRAM clock frequency change while preserving system efficiency, one solution is to record minimum clock cycle counts for different sets of command signals, address signals, and data signals. For instance, command signals sent from a DRAM controller to a DRAM shortly before and after a clock frequency change may be categorized into two groups: for those command signals belonging to a first group, the DRAM controller counts N1 clock cycles between issuing an active command and a precharge command; for those command signals belonging to a second group, the DRAM controller counts N2 clock cycles. This solution, however, complicates the DRAM controller design and is prone to errors.

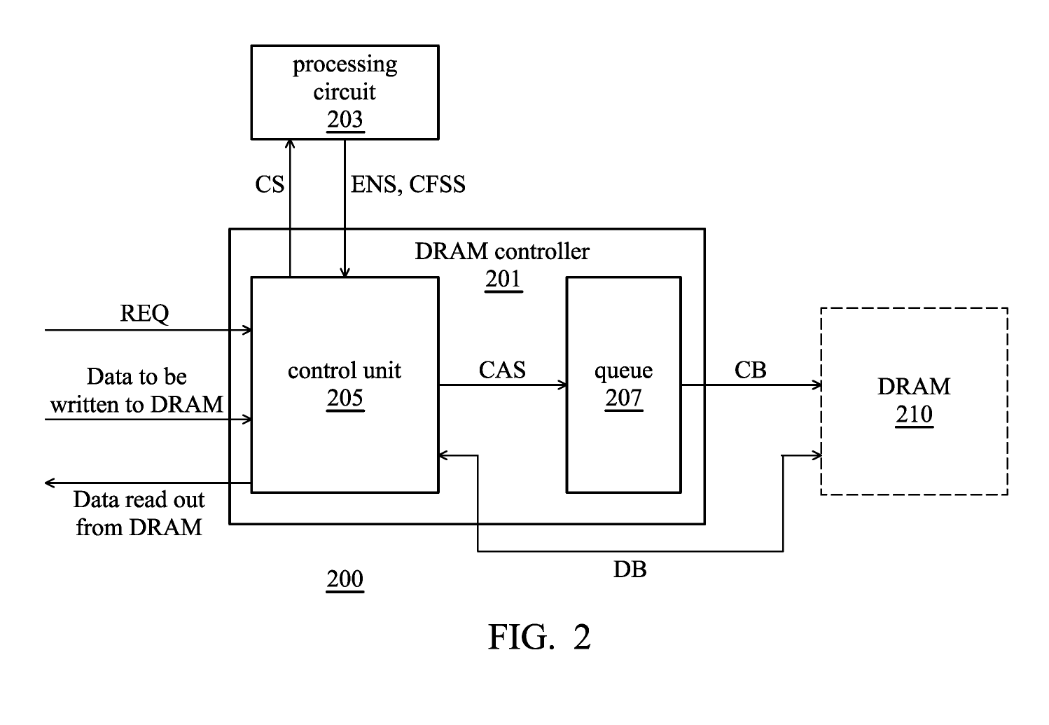

To illustrate an alternative solution, please begin with FIG. 2, which illustrates a block diagram of a DRAM subsystem 200 according to some embodiments of the invention. As shown in FIG. 2, the DRAM subsystem 200 comprises a DRAM controller 201 and a processing circuit 203. The DRAM controller 201 is coupled to the DRAM 210 through a command bus CB and a data bus DB. In response to a request REQ (usually a read/write request) from a computing unit such as a central processing unit (CPU) (not shown in FIG. 2), the DRAM controller 201 accordingly controls the read/write operation of the DRAM 210; thereby, controlling data, requested by the CPU, to be read out from or written into the DRAM 210 via the data bus DB. In practice, the DRAM subsystem 200 is fabricated within an integrated circuit (IC) chip; in contrast, the DRAM 210 is outside the IC (off-chip) and may be integrated with the IC chip on a printed circuit board (PCB) within an electronic device. The processing circuit 203 may be any combination of CPUs, GPUs, DSPs and/or other types of processors or any computing units; and some of the requests REQ may be issued forth from the processing circuit 203.

More specifically, the DRAM controller 201 comprises a control unit 205 and a queue 207. The control unit 205 may be combinations of sequential circuits and combinational circuits and the queue 207 may be implemented by registers or static random access memory (SRAM) and any combinations thereof. The control unit 205 receives the request REQ and prepares corresponding command and address signals CAS accordingly for storing (i.e. push) into the queue 207. The queue 207 may store up to N (a positive integer) pairs of command and address signals CAS that are to be sent to the DRAM 210. As N increases, the overall system performance may increase as well due to the better capability of concurrently processing requests from multiple computing units. To issue a command to the DRAM 210, the control unit 205 may execute a pop operation on the queue 207 so that a stored entry of the command and address signal CAS is popped out from the queue 207 and sent to the DRAM 210 via the command bus CB. The control unit 205 has to take care of the absolute timing margin between two consecutive pop operations as mentioned regarding FIG. 1. Note that, although the queue 207 is drawn to store a command signal and address signal for the DRAM 210, it is feasible that the queue 207 also stores those data to be written to the DRAM as well. It also has to be emphasized that there may be other detailed implementation choices pertaining to the DRAM controller 201, which shall be construed as being within the scope of this invention. For instance, the queue 207 may physically reside outside the DRAM controller 201.

In a given memory cycle there may be several commands in the queue 207 that are ready. The queue 207 may store commands corresponding to pending read and write requests and the control unit 205 may pick the commands of the pending requests out of order and issue them consecutively to the DRAM 210. The control unit 205 may record the commands of all the unfinished operations for a current operation mode (e.g., under current frequency) in the queue 207. The unfinished operations may comprise at least one ongoing operation which is the operation currently processed by the control unit 205 and remaining operations to be executed which are operations pending to be processed by the control unit 205 that are scheduled in an execution order. The operation may be a read operation or a write operation to access the DRAM 210.

When the clock frequency for the subsystem 200 (and for the DRAM 210) is about to be changed, the processing circuit 203 issues an early notification signal ENS in advance. The early notification signal ENS serves to notify the DRAM controller 201 that a clock frequency change is going to take place in the near future (say, within 5 ms). When the DRAM controller 201 receives the early notification signal ENS, it starts to re-schedule the sequence of the commands for the pending operations in the queue 207. For example, when the DRAM controller 201 receives the early notification signal ENS, all of the twelve commands for the four pending operations in the queue 207 are scheduled to be issued to the DRAM 210 according to an execution order; and then the DRAM controller 201 re-schedules the execution order of the twelve pending commands in the queue 207 by issuing ongoing commands for currently processed operations to the DRAM 210 first, inserting at least one command corresponding to the changing of the clock frequency to issue the inserted command to the DRAM 210 and recording the remaining unfinished commands for the remaining unfinished operations, and pausing the issuance of the remaining unfinished commands in the queue 207 during a certain time span before receiving a clock frequency switch signal CFSS, which requests a change of the clock frequency.

When the processing circuit 203 sends the clock frequency switch signal CFSS to the DRAM controller 201, the DRAM controller 201 pauses the issuance of the remaining unfinished commands in the queue 207. To manage the DRAM clock frequency change, a mode register write command (also referred to as a command for modifying the setting of the DRAM 210) MRW is issued from the DRAM controller 201 to the DRAM 210 to change the setting of DRAM 210 to meet the DRAM specification to change the frequency of the clock CLK to a new value. In some embodiments, a precharge-all command that can be used to precharge all banks of the DRAM 210 simultaneously (also referred to as a command for precharging all banks of the DRAM) is issued before issuing the command for modifying the setting of the DRAM according to the DRAM specification corresponding to a form of the DRAM 210 being used. For example, only the mode register write command MRW is needed to be issued if the DRAM 210 is a LDDR4 SDRAM, while the precharge-all command is issued first and then the mode register write command MRW can be issued if the DRAM 210 is a LDDR3 SDRAM.

In order to not suspend memory operations for a long period of time during clock frequency changes, once the inserted command (e.g., the mode register write command MWR) is successfully sent to the DRAM 210, the DRAM controller 201 then issues a clearance signal CS to the processing circuit 203 to indicate that the clock frequency for the DRAM controller 201 and/or the DRAM 210 can be changed. Then, the processing circuit 203 may switch the clock CLK to a new frequency under which the DRAM subsystem 200 may operate. In order to change to the new frequency as soon as possible, after the memory operation that has been processed is completed, the DRAM controller inserts the mode register write command MRW to the queue 207 and after the completion of the mode register write command MRW, the DRAM controller executes the remaining commands of all the unfinished operations.

With the rescheduling of the commands in the queue 207 upon receiving the early notification signal ENS, the time interval between receiving the clock frequency switch signal CFSS and issuing the clearance signal CS is effectively shortened. This is because, for example, finishing only ongoing commands for the currently processed operations is much faster than finishing all the commands for all the pending operations.

For the processing circuit 203, it senses that a time interval between requesting a clock frequency change (when issuing the clock frequency switch signal CFSS) and being able to change the clock frequency (when receiving the clearance signal CS) becomes smaller. Henceforth, any computing unit in need of accessing the DRAM 210 is kept waiting for a shorter time during the clock frequency switch process regarding the DRAM subsystem 200, and performance suffers less.

Thus, according to an embodiment of the invention, a computing system for accessing the DRAM 210 comprises the following circuits. The processing circuit 203 is configured for issuing the early notification signal ENS before issuing the clock frequency switch signal CFSS, wherein the early notification signal notifies of an approaching clock frequency switch signal CFSS and the clock frequency switch signal CFSS requests a change of frequency of a DRAM clock. The queue 207 comprises N entries, wherein N is a positive integer and each entry stores at least an address and an associated command to be sent to the DRAM 210. The DRAM controller 201 is configured to control access to the DRAM 210, wherein the DRAM controller 201 manages to reschedule the order of the commands in the queue 207 to insert a precharge-all command PREALL for precharging all banks simultaneously and a mode register write command MRW for modifying the setting of the DRAM 210 upon receiving the clock frequency switch signal CFSS.

In one embodiment of the invention, upon receiving the early notification signal ENS before the changing of the frequency of the DRAM clock, the DRAM controller 201 also records remaining commands of all the unfinished operations (pending operations) that are ready in the queue 207 to be executed on the DRAM 210 so that the DRAM controller 201 may resume or send remaining commands of all the unfinished operations to the DRAM 210 after the changing of the frequency of the DRAM clock.

In one embodiment of the invention, after receiving the clock frequency switch signal CFSS from the processing circuit 203, the DRAM controller 201 reorders the commands by finishing the execution of ongoing commands for currently processed operation, inserting a precharge-all command and a mode register write command and storing remaining unfinished commands, and executes remaining unfinished commands after the changing of the frequency of the DRAM clock. The precharge-all command can be used to precharge all banks of the DRAM 210 simultaneously. A precharged bank will be available for subsequent row access after a precharge command is issued. A mode register write command MRW can be used to modify the setting of the DRAM 210.

In another embodiment of the invention, the DRAM controller 201 selectively discards or inserts one or more commands within the remaining unfinished commands according to a determination of whether the remaining unfinished operations are corresponding to a same bank and a same row of the DRAM 210 after the changing of the frequency of the DRAM clock. In one embodiment, when the remaining unfinished operations correspond to different banks of the DRAM 210, the DRAM controller 201 discards all the N subsequent precharge commands among the remaining unfinished commands. In another embodiment, when the remaining unfinished commands correspond to the same bank and different rows of the DRAM 210, the DRAM controller 201 discards the first precharge command among the remaining unfinished commands. In yet another embodiment, when the remaining unfinished operations correspond to the same bank and the same row of the DRAM 210, the DRAM controller 201 inserts an active command in front of the remaining unfinished commands.

According to another embodiment of the invention, when the command for modifying the setting of the DRAM setting (i.e., the mode register write command MRW) is issued to the DRAM after receiving the clock frequency switch signal CFSS, the DRAM controller 201 issues the clearance signal CS to the processing circuit 203 to indicate that the frequency of the DRAM clock can be changed. According to another embodiment of the invention, the processing circuit 203 switches the frequency of the DRAM clock from a first frequency to a second frequency upon receiving the clearance signal CS. According to yet another embodiment of the invention, the DRAM controller 201 discards all the remaining unfinished commands of remaining unfinished operations after receiving the clock frequency switch signal CFSS.

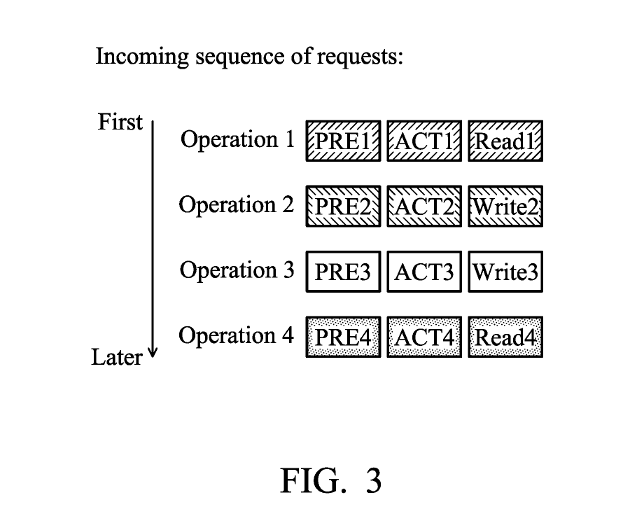

FIGS. 3-7 illustrate how the DRAM controller 201 manages to discard and re-schedule commands upon receiving the early notification signal ENS (and preferably before receiving the clock frequency switch signal CFSS). Referring to FIG. 3, in a given memory cycle, the DRAM controller 201 may receive four requests and schedules four operations corresponding to the received requests to be executed according to the incoming sequence of the requests.

In FIG. 3, there are four pending operations arranged from operation 1 to operation 4, wherein the operation 1 has commands of a first precharge command PRE1, a first active command ACT1 and a first read command Read1, the operation 2 has commands of a second precharge command PRE2, a second active command ACT2 and a second write command Write2, the operation 3 has commands of a third precharge command PRE3, a third active command ACT3 and a third write command Write3, and the operation 4 has commands of a fourth precharge command PRE4, a fourth active command ACT4 and a fourth read command Read4. The operation 1 is first executed (i.e., the commands of the operation 1 is first sent to the DRAM 210), and after execution of the operation 1 is completed, the operation 2, the operation 3 and the operation 4 are executed sequentially. The active command (e.g., ACT1-ACT4) should be applied before any read or write operation can be executed. The DRAM 210 can accept a read or write command (e.g., Read1, Write2, Write3, Read4) after the active command is issued. After a bank has been activated, it must be precharged before another active command can be applied to the same bank. The precharge command (e.g., PRE1-PRE4) is used to precharge or close a bank that has been activated. The precharge command can be used to precharge each bank independently.

The DRAM controller 201 schedules all the commands corresponding to the pending operations in a sequence, stores the commands to the queue and picks the commands out of order to be sent to the DRAM 210 according to the scheduled sequence.

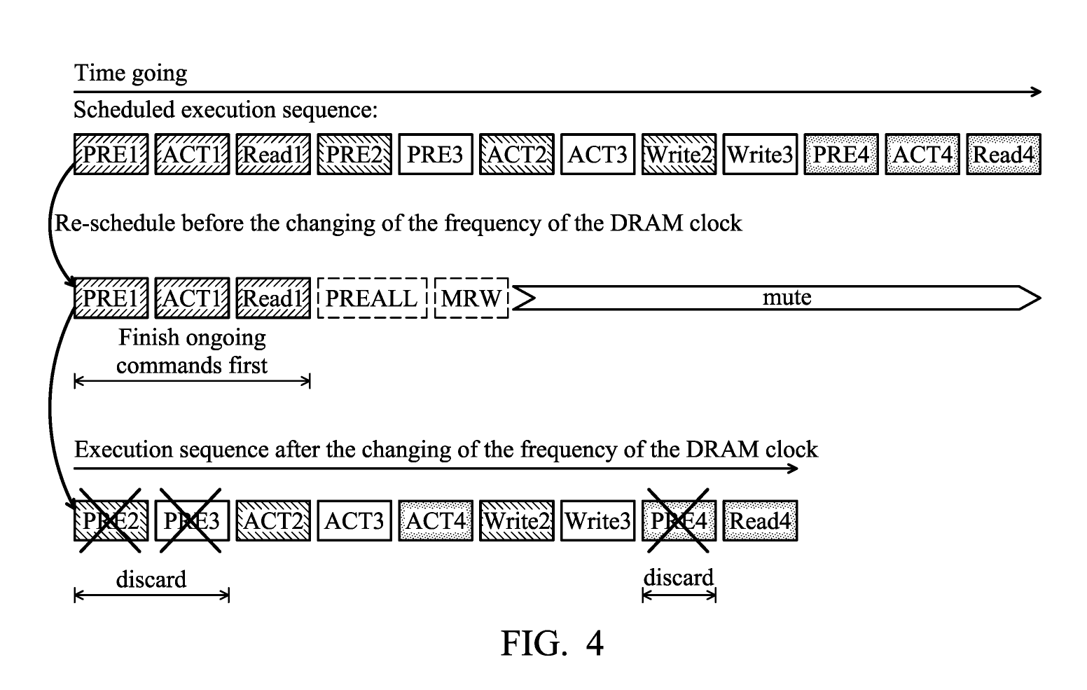

Referring to FIG. 4, it is assumed that the DRAM controller 201 receives the early notification signal ENS during processing of the operation 1 at which processing of the operations 2-4 are pending, and thus the DRAM controller 201 finishes ongoing commands (i.e., the first precharge command PRE1, the first activate command ACT1 and the first read command Read1) for the currently processed operation (i.e., the operation 1) first, then inserts the precharge-all command PREALL and the mode register write command MRW to reschedule the commands in the queue 207, and after the changing of the frequency of the DRAM clock, selectively discards subsequent commands based on a determination of whether the remaining commands for the remaining unfinished operations (i.e., the operations 2-4) are operated for the same bank and/or the same row, and sends the remaining unfinished commands to the DRAM 210. For instance, in this embodiment, the unfinished operations are the operations 2-4, and thus the remaining commands are the second precharge command PRE2, the second active command ACT2 and the second write command Write2 for the operation 2, the third precharge command PRE3, the third active command ACT3 and the third write command Write3 for the operation 3, and the fourth precharge command PRE4, the fourth active command ACT4 and the fourth read command Read4 for the operation 4.

In FIG. 4, it is assumed that all the operations operation 1-4 correspond to different banks of the DRAM 210. That is, if the operation 1 accesses a row of a first bank, the operation 2 may access a row of a second bank, the operation 3 may access a row of a third bank and the operation 4 may access a row of a fourth bank, wherein the first, second, third and fourth banks are different banks of the DRAM 210. “The operation 1 accesses a row of a first bank” means that the DRAM controller 201 may read data from the row of the first bank when the operation 1 is a read operation or it may write data into that row of the first bank when the operation 1 is a write operation. Since the inserted precharge-all command PREALL will be sent to the DRAM 210 after the ongoing commands have been finished and arranges all the banks of the DRAM 210 in precharged statuses, there is no need to resend precharge commands PRE2, PRE3 and PRE4 to the DRAM 210. Therefore, precharge commands PRE2, PRE3 and PRE4 can be discarded. When there are N precharge commands in the remaining commands, the DRAM controller 201 discards all the N subsequent precharge commands (e.g., PRE2 to PRE4), and sends the remaining commands to the DRAM 210 after the changing of the frequency of the DRAM clock. For instance, the second precharge command PRE2, the third precharge command PRE3 and the fourth precharge command PRE4 can be discarded if these four operations correspond to different banks. Thus, according to an embodiment of the invention, the DRAM controller 201 discards all the subsequent precharge commands among the remaining unfinished commands after the changing of the frequency of the DRAM clock when the remaining unfinished operations correspond to different banks.

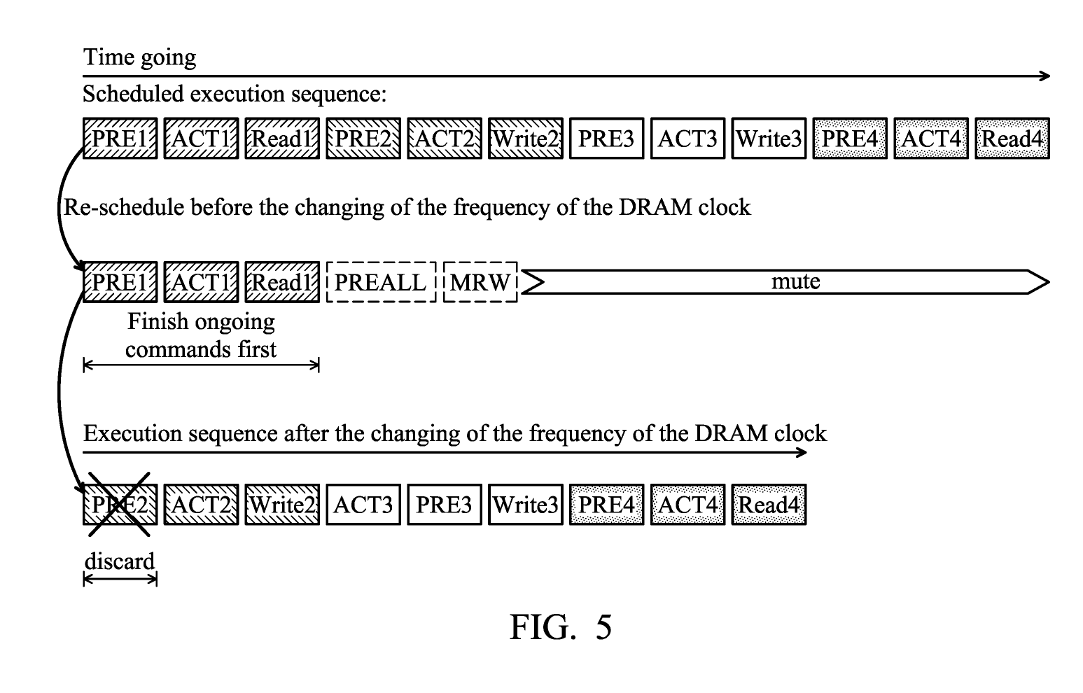

Referring to FIG. 5, similar to FIG. 4, it is assumed that the DRAM controller 201 receives the early notification signal ENS during processing of the operation 1, and thus the DRAM controller 201 finishes ongoing commands (i.e., the first precharge command PRE1, the first activate command ACT1 and the first read command Read1) for the currently processed operation (i.e., the operation 1) first, then inserts the command precharge-all PREALL and the command MRW to reschedule the commands in the queue 207, and after the changing of the frequency of the DRAM clock, selectively discards subsequent commands based on a determination of whether the remaining unfinished commands corresponding to the same bank and/or the same row, and executes the remaining unfinished commands.

In FIG. 5, it is assumed that all the operations 1-4 are corresponding to the same bank and a page miss occurs, which means that each of the four operations access a different row. A page miss is an access to a bank that is in the precharged state. The DRAM controller 201 may then send an activate command to open the desired page before the memory command may be ready. In this case, the DRAM controller 201 must send a precharge command to close the page and an activate command to open the desired page before the memory command may be ready. That is, if the operation 1 accesses a first row of a first bank, the operation 2 may access a second row of the first bank, the operation 3 may access a third row of the first bank and the operation 4 may access a fourth row of the first bank, wherein the first, second, third and fourth rows are different rows in the first bank of the DRAM 210. Since the inserted precharge-all command arranges all the banks of the DRAM 210 in precharged statuses, there is no need to resend the first precharge command (i.e., PRE2) among the remaining unfinished commands to the DRAM 210. Therefore, precharge command PRE2 which is the first precharge command among the remaining unfinished commands can be discarded. However, the DRAM controller 201 still needs to resend the precharge commands PRE3 and PRE4 because there is a page miss condition. For instance, the second precharge command PRE2 can be discarded if these four operations correspond to the same bank and a page miss occurs. Thus, according to another embodiment of the invention, the DRAM controller 201 discards the first precharge command among the remaining unfinished commands after the changing of the frequency of the DRAM clock when the remaining unfinished operations correspond to the same bank and different rows.

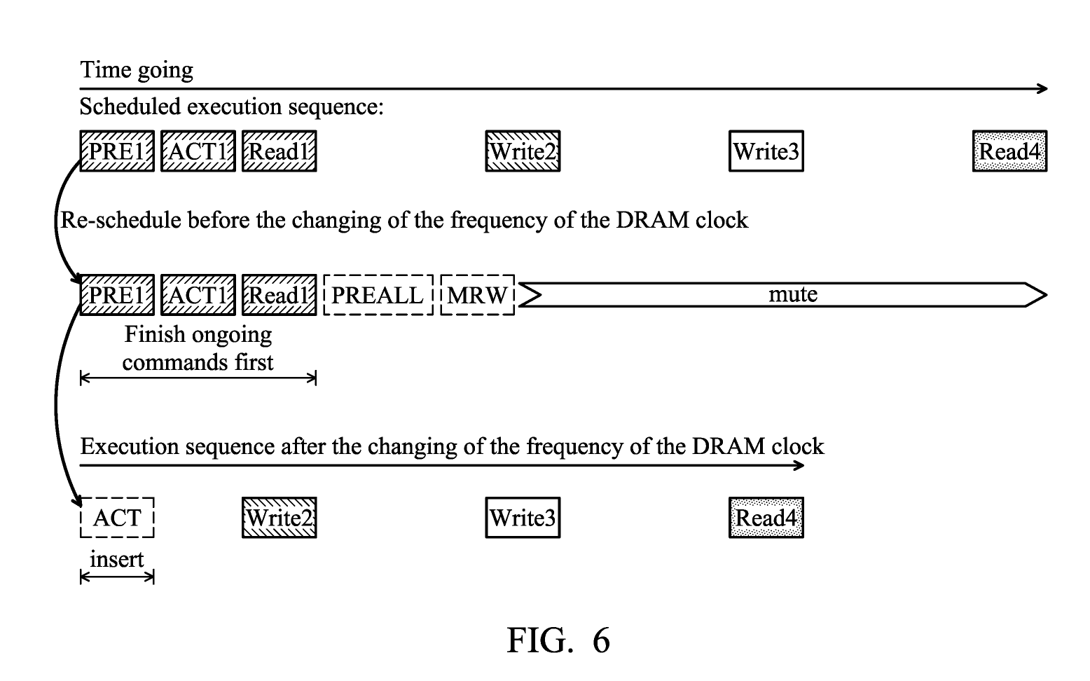

Referring to FIG. 6, it is assumed that all the operations 1-4 correspond to the same bank and a page hit occurs, which means that all the four operations also access the same row. A page hit generally occurs when the desired memory page is open for a given memory command. In this case, the command is ready to be sent to the DRAM 210. That is, if the operation 1 accesses a first row of a first bank, the operation 2, the operation 3 and the operation 4 also access the first row of the first bank. Under this condition, only the precharge command PRE1 and the active command ACT1 are needed to be sent to the DRAM 210 for precharging the first row of the first bank and activating the precharged bank for subsequent read/write commands. Thus, the DRAM controller 201 prepares the precharge command PRE1, the active command ACT1 and the read command Read1 for the operation 1, and then prepares the write command Write2, the write command Write3 and the read command Read4 for the operation 2, the operation 3 and the operation 4, respectively.

In FIG. 6, the DRAM controller 201 receives the early notification signal ENS during processing of the operation 1, and thus the DRAM controller 201 finishes ongoing commands (i.e., the precharge command PRE1, the activate command ACT1 and the read command Read1) for the currently processed operation (i.e., the operation 1) first, then inserts the precharge-all command PREALL and the mode register write command MRW to reschedule the commands in the queue, and after the changing of the frequency of the DRAM clock, selectively discards subsequent precharge commands or inserts an active command based on a determination of whether the remaining unfinished commands are corresponding to the same bank and the same row, and executes the remaining unfinished commands.

Since the inserted precharge-all command arranges all the banks of the DRAM 210 in precharged statuses, there is no need to send any precharge command to the DRAM 210. However, an active command is needed to be inserted before the read or write command among the remaining unfinished commands can be accessed to the DRAM 210. Accordingly, the DRAM controller 201 needs to insert an active command ACT to activate the bank because there is a page hit condition. For instance, the active command ACT can be inserted in front of the remaining unfinished commands so that the active command ACT is issued to the DRAM 210 first. Thus, according to another embodiment of the invention, the DRAM controller 201 inserts an active command in front of the remaining unfinished commands after the changing of the frequency of the DRAM clock when the remaining unfinished operations correspond to the same bank and the same row.

According to another embodiment of the invention, the DRAM controller 201 manages to reschedule the order of the commands in the queue 207 to insert the mode register write command MRW only upon receiving the clock frequency switch signal CFSS. In one embodiment of the invention, upon receiving the early notification signal ENS before the changing of the frequency of the DRAM clock, the DRAM controller 201 also records remaining commands of all the unfinished operations (pending operations) that are ready in the queue 207 to be executed on the DRAM 210 so that the DRAM controller 201 may resume or send remaining commands of all the unfinished operations to the DRAM 210 after the changing of the frequency of the DRAM clock.

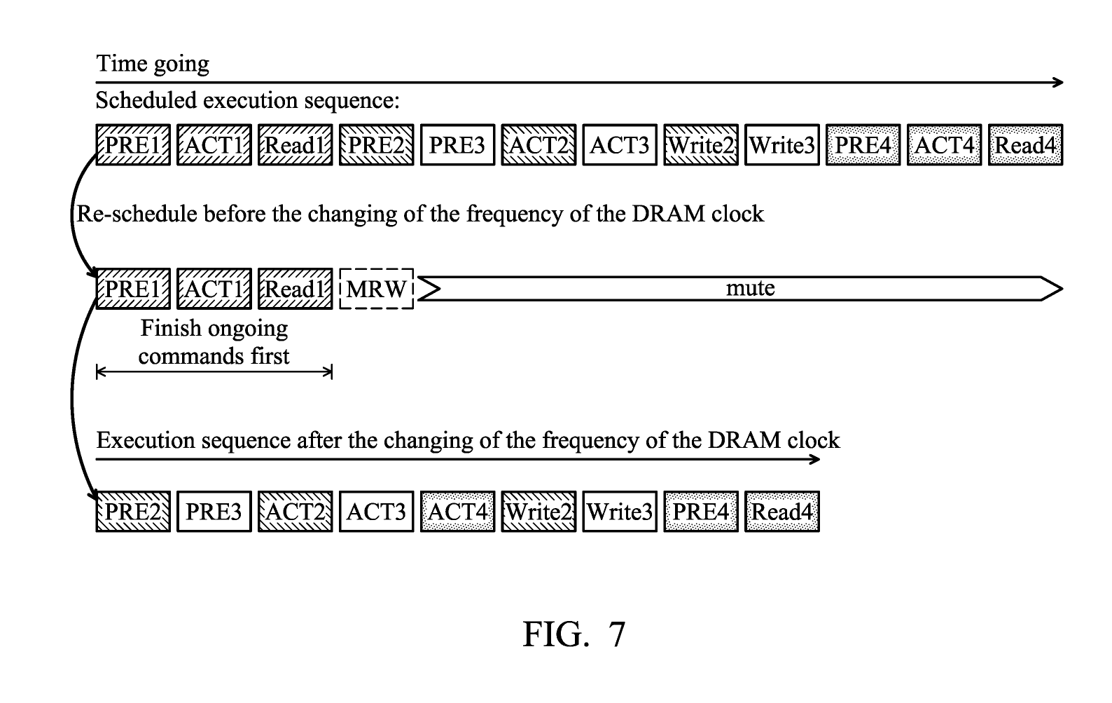

Referring to FIG. 7, it is assumed that the DRAM controller 201 receives the early notification signal ENS during processing of the operation 1 at which processing of the operations 2-4 are pending, and thus the DRAM controller 201 finishes ongoing commands (i.e., the first precharge command PRE1, the first activate command ACT1 and the first read command Read1) for the currently processed operation (i.e., the operation 1) first, then inserts the mode register write command MRW to reschedule the commands in the queue 207, and after the changing of the frequency of the DRAM clock, it sends the remaining unfinished commands for the remaining unfinished operations to the DRAM 210. For instance, in this embodiment, the remaining unfinished operations are the operations 2 to 4, and thus the remaining unfinished commands are the second precharge command PRE2, the second active command ACT2 and the second write command Write2 for the operation 2, the third precharge command PRE3, the third active command ACT3 and the third write command Write3 for the operation 3, and the fourth precharge command PRE4, the fourth active command ACT4 and the fourth read command Read4 for the operation 4. In this embodiment, as no precharge-all command is issued in advance, after the changing of the frequency of the DRAM clock, no command among the remaining unfinished commands will be discarded.

According to yet another embodiment of the invention, the processing circuit 203 is also configured for issuing the early notification signal ENS to the external computing unit such as a central processing unit (CPU) (not shown in FIG. 2) that issues the requests before issuing the clock frequency switch signal CFSS. In this embodiment, upon receiving the early notification signal ENS before the changing of the frequency of the DRAM clock, the external computing unit may record or backup all the unfinished requests, and it resends all the recorded requests to the DRAM controller 201 after the changing of the changing of the frequency of the DRAM clock. Also, at the time instant that the processing circuit 203 switches the clock CLK for the DRAM subsystem 200 from a first frequency to a second frequency, the DRAM controller 201 just needs to finish ongoing commands for currently processed operation and issue a command for modifying the setting of the DRAM and all the remaining unfinished commands for the remaining unfinished operations under the first frequency have been completely discarded. As such, there is no need for the DRAM controller 201 to record the remaining unfinished commands. The DRAM controller 201 may then calculate a new clock cycle count under the second frequency for meeting the requirement of the DRAM timing interval between two commands.

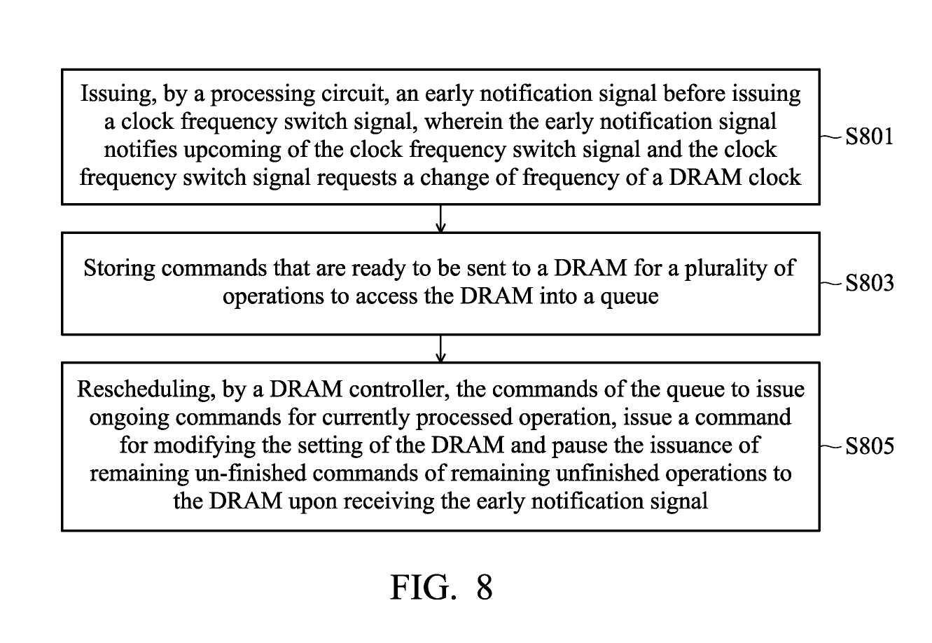

FIG. 8 is a flow chart illustrating a DRAM accessing method according to an embodiment of the invention. In step S801, an early notification signal is issued before a clock frequency switch signal is issued, wherein the early notification signal notifies of an approaching clock frequency switch signal and the clock frequency switch signal requests a change of frequency of a DRAM clock. In step S803, commands that are ready to be sent to a DRAM for a plurality of operations to access the DRAM are stored into a queue having N entries, wherein each entry stores at least an address and associated command. In step S805, the commands of the queue are rescheduled to issue ongoing commands for currently processed operation, issue a command for modifying the setting of the DRAM and pauses the issuance of remaining unfinished commands of remaining unfinished operations to the DRAM upon receiving the early notification signal. In some embodiments, a command for precharging all banks of the DRAM is issued before issuing the command for modifying the setting of the DRAM according to the DRAM specification corresponding to a form of the DRAM being used.

The method in FIG. 8 may be performed by hardware (e.g., circuitry, dedicated logic, programmable logic, microcode, application specific integrated circuits (ASICs), field-programmable gate arrays (FPGAs), etc.), software (e.g., instructions run on a processing device), or a combination thereof. In one embodiment, the method is performed by the DRAM subsystem 200 of FIG. 2.

The operations of the flow diagram of FIG. 8 have been described with reference to the exemplary embodiments of FIGS. 2-7. However, it should be understood that the operations of the flow diagrams of FIG. 8 can be performed by embodiments of the invention other than those discussed with reference to FIGS. 2-7, and the embodiments discussed with reference to FIGS. 2-7 can perform operations that are different than those discussed with reference to the flow diagrams. While the flow diagrams of FIG. 8 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through thermal sensors and circuits (either dedicated circuits, or general purpose circuits, which operate under the control of one or more processors and coded instructions), which will typically comprise transistors that are configured in such a way as to control the operation of the circuitry in accordance with the functions and operations described herein. As will be further appreciated, the specific structure or interconnections of the transistors will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A computing system for accessing a dynamic random access memory (DRAM), the computing system comprising:
a processing circuit, configured for issuing an early notification signal before issuing a clock frequency switch signal, wherein the early notification signal notifies of an approaching clock frequency switch signal and the clock frequency switch signal requests a change of frequency of a DRAM clock;
a queue comprising entries for storing commands that are ready to be sent to the DRAM for a plurality of operations to access the DRAM; and
a DRAM controller, configured to control access to the DRAM, wherein the DRAM controller manages to reschedule the commands of the queue to issue ongoing commands for currently processed operations, issue a command for modifying the setting of the DRAM and pause the issuance of remaining unfinished commands of remaining unfinished operations to the DRAM upon receiving the early notification signal.

2. The computing system of claim 1, wherein the DRAM controller further issues a command for precharging all banks of the DRAM before issuing the command for modifying the setting of the DRAM.

3. The computing system of claim 2, wherein the DRAM controller selectively discards or inserts one or more commands within the remaining unfinished commands according to a determination of whether the remaining unfinished operations are corresponding to a same bank and a same row of the DRAM and resumes or issues remaining commands of all the remaining unfinished operations to the DRAM after the changing of the frequency of the DRAM clock.

4. The computing system of claim 3, wherein the DRAM controller discards all the subsequent precharge commands among the remaining unfinished commands after the changing of the frequency of the DRAM clock when the remaining unfinished operations correspond to different banks of the DRAM.

5. The computing system of claim 3, wherein the DRAM controller discards the first precharge command among the remaining unfinished commands after the changing of the frequency of the DRAM clock when the remaining unfinished operations correspond to the same bank and different rows of the DRAM.

6. The computing system of claim 3, wherein the DRAM controller inserts an active command in front of the remaining unfinished commands after the changing of the frequency of the DRAM clock when the remaining unfinished operations correspond to the same bank and the same row of the DRAM.

7. The computing system of claim 1, wherein when the command for modifying the setting of the DRAM setting is issued to the DRAM after receiving the clock frequency switch signal, the DRAM controller issues a clearance signal to the processing circuit to indicate that the frequency of the DRAM clock can be changed.

8. The computing system of claim 7, wherein the processing circuit switches the frequency of the DRAM clock from a first frequency to a second frequency upon receiving the clearance signal.

9. The computing system of claim 1, wherein the DRAM controller discards all the remaining unfinished commands of remaining unfinished operations after receiving the clock frequency switch signal.

10. A dynamic random access memory (DRAM) accessing method, the DRAM accessing method comprising:
issuing, by a processing circuit, an early notification signal before issuing a clock frequency switch signal, wherein the early notification signal notifies of an approaching clock frequency switch signal and the clock frequency switch signal requests a change of frequency of a DRAM clock;
storing commands that are ready to be sent to a DRAM for a plurality of operations to access the DRAM into a queue; and
rescheduling, by a DRAM controller, the commands of the queue to issue ongoing commands for currently processed operations, issuing a command for modifying the setting of the DRAM and pausing the issuance of remaining unfinished commands of remaining unfinished operations to the DRAM upon receiving the early notification signal.

11. The DRAM accessing method of claim 10, wherein a command for precharging all banks of the DRAM is issued, by the DRAM controller, before issuing the command for modifying the setting of the DRAM.

12. The DRAM accessing method of claim 11, further comprising:
discarding or inserting, by the DRAM controller, one or more commands within the remaining unfinished commands according to a determination of whether the remaining unfinished operations are corresponding to a same bank and a same row of the DRAM and resuming or issuing remaining commands of all the remaining unfinished operations to the DRAM after the changing of the frequency of the DRAM clock.

13. The DRAM accessing method of claim 12, wherein all the subsequent precharge commands among the remaining unfinished commands are discarded after the changing of the frequency of the DRAM clock when the remaining unfinished operations correspond to different banks of the DRAM.

14. The DRAM accessing method of claim 12, wherein the first precharge command among the remaining unfinished commands is discarded after the changing of the frequency of the DRAM clock when the remaining unfinished operations correspond to the same bank and different rows of the DRAM.

15. The DRAM accessing method of claim 12, wherein an active command is inserted in front of the remaining unfinished commands after the changing of the frequency of the DRAM clock when the remaining unfinished operations correspond to the same bank and the same row of the DRAM.

16. The DRAM accessing method of claim 11, wherein when the command for modifying the setting of the DRAM setting is issued to the DRAM after receiving the clock frequency switch signal, a clearance signal is issued to the processing circuit to indicate that the frequency of the DRAM clock can be changed.

17. The DRAM accessing method of claim 16, wherein the frequency of the DRAM clock is switched, by the processing circuit, from a first frequency to a second frequency upon receiving the clearance signal.

18. The DRAM accessing method of claim 11, wherein all the remaining unfinished commands of remaining unfinished operations are discarded, by the DRAM
